(19) United States
(12) Patent Application Publication
(10) Pub. No.: US 2012/0274512 A1
(43) Pub. Date: Nov. 1, 2012

(54) Signal Processing Method, Device and System

(75) Inventor: Timo Jokitalo, Helsinki (FI)

(73) Assignee: FASTRAX LTD., Espoo (FI)

(21) Appl. No.: 13/458,530

(22) Filed: Apr. 27, 2012

(30) Foreign Application Priority Data
Apr. 28, 2011 (FI) 20115405

(51) Int. Cl. G01S 19/30; H04B 1/709

(52) U.S. Cl. 342/357.69; 375/150; 375/E01.003

(57) ABSTRACT

An aspect of the invention is a signal processing method for correlating an N-bit received signal with an N-bit code word signal, wherein the method comprises steps of preprocessing said N-bit received signal and said N-bit code word signal, performing a Fourier transform (126) for said preprocessed signals, multiplying (130) said Fourier transformed preprocessed received signal with said Fourier transformed preprocessed code word signal, and performing inverse Fourier transform (140) to a product of said multiplication. The method is characterized in that said preprocessing comprises a step of resampling (123, 125; 135) at least one of said signals with N bits to a length of at least N+1 bits with interpolation means.

### TECHNICAL FIELD OF INVENTION

The invention relates to a method, device and system for signal processing.

### BACKGROUND OF THE INVENTION

Signals transmitted from Global Navigation Satellite System (GNSS) satellites consist of a carrier frequency modulated by a pseudo-random noise (PRN) code that is unique to each satellite.

All the satellites transmit at the same carrier frequency, but due to the high velocity of the satellites the signals will experience a Doppler shift in frequency before reaching the GNSS receiver. The Doppler shift can be several kHz in magnitude.

The pseudo-random noise (PRN) code sequence is 1023 units or chips long and repeats itself continuously. The code phase at the receiver at any given time is dependent on the distance between the receiver and the satellite.

There are several ways of acquiring signals from GNSS satellites. All these methods rely on the effect of autocorrelation, wherein a GNSS receiver will generate exact replicas of a carrier frequency and pseudo-random noise code and multiply these replicas with the incoming signal. If the carrier frequency and code phase of the generated signals match the ones in the incoming signal, it will produce maximum correlation power and the resulting mixed signal is easily detectable.

A straightforward way of acquiring the signals is to do a serial search, i.e. testing with all possible frequencies and code phases. In this case the total number of combinations is over 40 000 for each satellite signal (1023 code phases and 40 frequencies). Moreover, the trivial implementation of the code search has complexity N̂2, so that calculating the 1023 code phases for one satellite needs at least 1023̂2 operations which is over a million operations.

One way to speed up the calculation of the code search is to use the Fourier transform to calculate the correlation. In this method the Fast Fourier Transform (FFT) is done for a received signal and for a PRN code sequence, the transformed values are multiplied with each other and the inverse FFT is done on the result. With this method, the number of operations needed is significantly less. The complexity is in fact C*N*log2 N, where C is a constant depending on the FFT method used.

A problem in the Fourier transform method is that the PRN code sequence is 1023 bits long which is not an ideal length for FFT. The most common and most efficient form of the Cooley-Tukey FFT algorithm works by recursively dividing the transform length by 2, and Therefore the transform length for this algorithm needs to be a power of 2. The Cooley-Tukey FFT algorithm can be also written to recursively divide the transform length by other numbers than 2, resulting in a so-called mixed-radix FFT algorithm. The mixed-radix FFT is also quite efficient when the transform length is a number with only small prime factors, for example 2, 3 and 5. The length of the GPS PRN code sequence is 1023=3*11*31, a number for which the mixed-radix FFT does not perform well. There are also FFT algorithms which work for any transform length, but the performance of these is significantly worse than the power of 2 FFT or mixed radix FFT for lengths with small prime factors.

Because of the fact that power of 2 FFT or mixed radix FFT for lengths with small prime factors are most efficient, it is a common approach to adjust the transform length to a power of two or a length with only small prime factors.

This is commonly done by zero padding where zeros are appended to the data before the FFT. For the correlation to work properly, the zero-padded data has to be at least twice the length of the original data, so that to correlate a PRN sequence of length 1023, an FFT of length 2048 should be used.

Another way to perform the FFT on a sequence of data for which the FFT is efficient is to resample the data so that the resampled data has a suitable length. One way to do this is to oversample the data by repeating the samples, then filtering the oversampled data with a low pass filter and then extracting samples from this filtered data sequence to obtain a sequence of data which has a length suitable for the FFT, preferably the smallest power of two larger than the length of the original data. Another way to adjust the length of the data is to choose the nearest neighbor for each point of the original data. This method is requires a lot of computing effort. Another way to adjust the length of the data is to choose the nearest neighbor for each point in the data. This is a method which requires very little computation effort but in practice it introduces too much noise in the results to be practical.

### OBJECT OF THE INVENTION

One of the objects of the present invention is to provide a method, device and/or system for reducing CPU time or amount of computation needed to acquire a spread spectrum signal from a received RF signal.

### SUMMARY OF THE INVENTION

The invention discloses a signal processing method, device and system for acquisition of a spread spectrum signal from e.g. GNSS system.

The first aspect of the invention is a signal processing method for correlating an N-bit received signal with an N-bit code word signal, wherein the method comprises steps of preprocessing said N-bit received signal and said N-bit code word signal, performing a Fourier transform for said preprocessed signals, multiplying said Fourier transformed preprocessed received signal with said Fourier transformed preprocessed code word signal, and performing inverse Fourier transform to a product of said multiplication. The method is characterized in that said preprocessing comprises a step of resampling at least one of said signals with N bits to a length of at least N+1 bits with interpolation means.

In an embodiment of the first aspect of the invention, said interpolation means comprises means for cubic spline interpolation.

In an embodiment of the first aspect of the invention, said length of at least N+1 bits is a power of two.

In an embodiment of the first aspect of the invention, said length of at least N+1 bits is a number having only prime factors equal or smaller than 5.

In an embodiment of the first aspect of the invention, said interpolation means comprises a simplified approximation to the cubic spline interpolation.

A signal processing module, characterized in that said module is arranged to perform the method of claim 1.

The second aspect of the invention is a signal processing module. The module is characterized in that said module comprises interpolation means for interpolating an N-bit received signal and an N-bit code word signal to signals having a length of at least N+1 bits, Fourier transform means for performing a Fourier transform to said interpolated signals, multiplying means for multiplying said Fourier transformed preprocessed received signal with said Fourier transformed preprocessed code word signal, and inverse Fourier transfer means for performing inverse Fourier transform to a product of said multiplication.

In an embodiment of the second aspect of the invention, said interpolation means comprises means for cubic spline interpolation.

In an embodiment of the second aspect of the invention, said length of at least N+1 bits is a power of two.

The third aspect of the invention is a device comprising the signal processing module according to the second aspect of the invention.

The fourth aspect of the invention is a positioning system comprising the device of the third aspect of the invention.

The fifth aspect of the invention is a navigation system comprising the device of the third aspect of the invention.

The sixth aspect of the invention is use of the device of the third aspect of the invention as a system element in navigation and/or positioning system.

Some embodiments of the invention are described herein, and further applications and adaptations of the invention will be apparent to those of ordinary skill in the art.

### BRIEF DESCRIPTION OF DRAWINGS

In the following, the invention is described in greater detail with reference to the accompanying drawing in which

FIG. 1 shows an exemplary schematic diagram of signal processing in an embodiment of the invention.

### DETAILED DESCRIPTION OF THE DRAWINGS

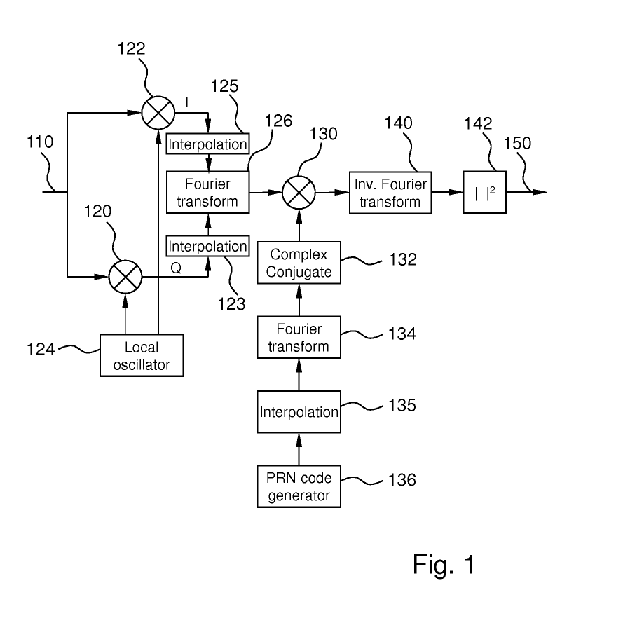

FIG. 1 shows an exemplary schematic diagram of signal processing in an embodiment of the invention. A module of this embodiment implementing the illustrated schematic diagram of the FIG. 1 may be used in processing GNSS signals. The module may be implemented by hardware, software or a combination of hardware and software elements.

An incoming signal 110 is demodulated into in-phase (I) and quadrature phase (Q) signals using two mixers 120, 122 and local oscillator 124 operating at a certain frequency. These I and Q signals are interpolated 123, 125. The interpolation results are then Fourier transformed 126 and the outputs are forwarded to a third mixer 130. The interpolation can be done with several interpolation methods, such as linear interpolation, spline interpolation with varying degree and varying interpolation point locations and also with varying weighting functions. Different interpolation methods produce different results which can most easily be compared with experimentation. The interpolation is preferably done with cubic spline interpolation with uniform interpolation nodes, because the interpolation results are acceptable for the purpose of resampling the input data for the Fourier transform, and because the practical implementation is simpler with uniform node locations.

A PRN code generator 136 generates a code word signal using code words which are stored in the PRN code generator or memory means which the PRN code generator is configured to access. The code words are generated according to the specification of the signal, for example for GPS C/A code they are generated with a shift register. For quicker access and to avoid regenerating the code words, they can be stored in the memory. For interpolation, the PRN code is considered as a sequence of samples with values 1 and −1.

The code word signal is then interpolated 135 to the same length as the interpolated demodulated signals. The interpolated 135 code word signal is then Fourier transformed 134 and complex conjugate 132 of the Fourier transformed code word signal is fed to the third mixer 130. The interpolated and Fourier transformed code words can also be stored into memory to avoid regenerating them when the same process is repeated, i.e. when a new acquisition is done with the same PRN code.

In an embodiment, the code word signal comprises at least two different code words for searching at least two different signals within the incoming signal. In this embodiment, the interpolated and Fourier transformed code words of different PRN codes are added element-wise so that the resulting code word signal is a linear combination of the code word signals of individual PRN codes. The code word signal may comprise all the available code words, two, three, four, five or six code words or any other number of code words.

The third mixer 130 outputs mixing result of the complex conjugate of the Fourier transformed interpolated code word signal and the demodulated, interpolated and Fourier transformed incoming signal. An inverse Fourier transform 140 is performed to the output signal of the third mixer and the result is normalized 142 to produce an output 150 of the signal processor.

The output 150 shows correlation if the code word of the code word signal exists in the incoming signal and they are in the chosen frequency band.

In an embodiment where multiple signals are used and the code word signal comprises multiple code words, the output 150 shows correlation for all the signals having the same code word as were used in the code word signal if the signals exist in the incoming signal and they are in the chosen frequency band. The extraction of the correlation result shows a peak for each signal that exists in the incoming signal and in the chosen frequency band. The position of the peak in the correlation corresponds to the phase of the PRN code in the incoming signal. If there are no distinguishable peaks in the correlation, it means that the signal is not present in the signal or that it is too weak to detect with the number of samples used in the acquisition process.

The frequency band can be modified by changing the output frequency of the local oscillator 124. The local oscillator can be adjusted to search signals having for example −4 kHz to +4 kHz frequency offset, which is usually caused by Doppler shifting. The output shows phase of the code word and frequency shift of the found signals which can then be easily acquired.

The total number of computations required to acquire signal from a number of satellites is significantly lower using the method of the above-mentioned embodiment compared to conventional signal acquisition methods.

In an embodiment of the invention, the above-mentioned module is arranged in connection of a device. The device may be for example navigation device, positioning device, mobile phone, digital camera, digital camcorder or some other device with a positioning or navigation function. The module can be integrated into the device, or be a separate module in the device, or a physically separate module that is arranged to be connected to the device with wireless or wired connection.

In an embodiment of the invention, the method also comprises preprocessing step for received signal and/or code word signal. The number of bits in a signal is increased in the preprocessing step in order to make the length of the signal more suitable for Fast Fourier Transform (FFT) without unnecessarily increasing the length of the FFT to be performed.

When the number of bits is increased, the original bits of the signal are re-distributed along the new length by means of interpolation. Several different interpolation methods are possible, for example linear interpolation and cubic spline interpolation. Preferably, the interpolation method is cubic spline interpolation. The cubic spline interpolation method seems to represent the information of the original signal better than some other interpolation methods.

Re-distributing of bits to a new length may reduce calculations required for performing FFT if the new length suits better for FFT than the original length. Preferably the new length is the smallest such number larger than the original length which has only small prime factors 2 and 3. For example, if the method is applied to a hypothetical sample sequence of length 1100, a good new length would be 1152=2̂7*3̂2. When the original sequence has length 1023, the preferable new length would be 1024=2̂10.

Different interpolation methods produce different results when signals are correlated after the interpolation as explained earlier.

In an embodiment of the invention, the device comprising the signal processing module can be a part of a positioning or navigation system. The device can be for example a GNSS receiver comprising the signal processing module according to an embodiment of the invention. The GNSS receiver receives positioning signals from a satellite navigation system and processes the received signals with said signal processing module. The receiver may be arranged to transmit location data to another device of the navigation and/or positioning system, for example to a display unit or to a system in a vehicle in which the receiver is being used.

Although some embodiments or examples have been described in connection with the Global Positioning System (GPS), the presented inventive concept may be utilized in connection with various present and future satellite navigation systems, for example, such as GLONASS, Galileo, COMPASS, etc.

To a person skilled in the art, the foregoing exemplary embodiments illustrate the model presented in this application whereby it is possible to design different methods and arrangements, which in obvious ways to the expert, utilize the inventive idea presented in this application.

1-13. (canceled)

14. A signal processing method for correlating an N-bit received signal with an N-bit code word signal, comprising:
preprocessing, in an electronic signal processor, the N-bit received signal and the N-bit code word signal,
performing a Fourier transform on the preprocessed N-bit received signal and the preprocessed N-bit code word signal,
multiplying the Fourier-transformed preprocessed N-bit received signal with the Fourier-transformed preprocessed N-bit code word signal, and
performing an inverse Fourier transform on a product of the multiplying,
wherein preprocessing comprises resampling at least one of the N-bit signals to a length of at least N+1 bits by interpolation.

15. The method of claim 14, wherein interpolation comprises cubic spline interpolation.

16. The method of claim 14, wherein the length of at least N+1 bits is a power of two.

17. The method of claim 14, wherein the length of at least N+1 bits is a number having only prime factors less than or equal to 5.

18. The method of claim 14, wherein interpolation comprises approximate cubic spline interpolation.

19. A signal processing module, comprising:
an interpolator configured for interpolating an N-bit received signal and an N-bit code word signal, thereby generating interpolated received and code word signals having lengths of at least N+1 bits,
a Fourier transformer configured for performing a Fourier transform on the interpolated received and code word signals, thereby generating Fourier-transformed received and code word signals,
a multiplier configured for multiplying the Fourier-transformed received signal with the Fourier-transformed code word signal, thereby generating a product, and
an inverse Fourier transformer configured for performing an inverse Fourier transform on the product.

20. The signal processing module of claim 19, wherein the interpolator is configured for cubic spline interpolation.

21. The signal processing module of claim 19, wherein the length of at least N+1 bits is a power of two.

22. A signal receiver, comprising a signal processing module according to claim 19.

23. The signal receiver of claim 22, wherein the signal receiver is included in a positioning system.

24. The signal receiver of claim 22, wherein the signal receiver is included in a navigation system.
